(19) United States
(12) Patent Application Publication
(10) Pub. No.: US 2013/0097373 A1
(43) Pub. Date: Apr. 18, 2013

(54) SYSTEMS AND METHODS OF MANAGING HARD DISK DEVICES

(71) Applicant: Yat Wai Edwin Kwong, Causeway Bay (HK)

(72) Inventor: Yat Wai Edwin Kwong, Causeway Bay (HK)

(21) Appl. No.: 13/274,057

(22) Filed: Oct. 14, 2011

(51) Int. Cl. G06F 12/16

(52) U.S. Cl. 711/112; 711/E12.103

(57) ABSTRACT

Systems and methods of managing hard disk devices are provided to wirelessly receive instructions from a user to enable safety features with respect to various conditions encountered by the hard disk devices. These conditions include changes in location, orientation, and the light intensity. Such changes initiate functions which serve to backup and protect the data stored on the hard drive.

### FIELD OF THE INVENTION

This invention generally relates to managing hard disk devices under conditions requiring high-security measures. More specifically, this invention ensures that certain sectors deemed as protected areas are backed up at appropriate times, and the backed up data is wirelessly uploaded to servers. When high-security conditions cease, such data can be recovered to the hard disk seamlessly.

### BACKGROUND OF THE INVENTION

Information technology security is an increasingly popular topic. Recently, larger and larger amounts of data are stored in hard disks. Much of which may contain highly confidential information with respect not only to corporations but individuals. Therefore, there is a need to further increase the integrity of data contained in hard disks. External hard disks are very useful. For example, they provide mobility that is unavailable to internal hard disks. A user may save data to an external hard disk and connect the disk to another computer in order to have the data transferred to that computer. A user may also use an external hard disk to back up data from their computer, and restore that data later on to the same computer or a different computer. The challenge is that the hard disk must be backed up regularly in order to keep the backed up copy up to date. There is an unfulfilled need in the art for a device that systematically initiates data backup at the appropriate times, and in response to appropriate stimulus. In view of the foregoing, there is a need for novel methods and systems

to handle hard disk devices systematically.

### SUMMARY OF THE INVENTION

According to embodiments of the invention, a hard disk for allowing provisioning of safety features is provided. The hard disk comprises the following components: a location identifying device, an accelerator, a photo resistor, a wireless transmitter, an uploading server associated with a phone carrier, a processor, and a memory storage device.

The memory stores instructions to be executed by the processor, and are as follows. Initially, an instruction is wirelessly received from a user in order to enable a safety feature with respect to the hard disk. The user is an end user of a mobile phone, whose network coverage from the phone carrier includes a geographic area. The geographic area may be, but is not limited to, the boundaries of a State or Country. Next, the user is prompted for information needed in order to enable a safety feature. The information asked of the user may include: sub-geographic region that is a smaller region within the geographic area, wherein the sub-geographic region is labeled as a dangerous reception area; a sub-sub-geographic region that is a smaller region within the sub-geographic area, wherein the sub-sub-geographic region is labeled as a safe reception area; a building that is within the geographic area, wherein the building is labeled as a very dangerous reception area; a floor of the building, wherein the floor is labeled as a safe reception area; an embassy building that is within the geographic area, wherein the embassy building is labeled as an extremely dangerous reception area; and an open area within the embassy, wherein the open area is labeled as a safe reception.

An answer is then received. The answer includes information regarding sub-geographic region, the sub-sub-geographic region, the building, the floor of the building, the embassy, and the open area.

Next, the safety feature is enabled in view of the received answer to complete configuration thereof. Then, upon receiving information regarding the sub-geographic region labeled as the dangerous reception area by a third party unknown to the user, and determining, with the location-identification device, the current location to be within the dangerous reception area, the following steps are taken: a) backing up data located in certain predefined sectors of the hard disk, wherein the sectors are regarded as sensitive areas; b) uploading the backed data wirelessly through the wireless transmitter to the loading server; and c) erasing the backed up data.

Finally, upon leaving the sub-geographic region labeled as the dangerous reception area, and determining, with the location-identification device, the current location to be within the safe reception area, the erased data is recovered wirelessly.

In another embodiment of the invention, the user is further prompted for additional information regarding movement of the hard disk. The user is asked to denote an orientation change, which, when triggered, would cause the hard disk to back up data. The user's answer, along with the location-based data referred to above, would contain information regarding the magnitude and direction of an orientation change sufficient to trigger data backup. The safety features are then configured in response to the user's answers.

In this embodiment, upon detection, by the accelerometer, that the hard disk is being moved in a way consistent with the denoted orientation movement, the following steps are taken: a) backing up the data with respect to the orientation movement; b) uploading the backed data wirelessly through the wireless transmitter to the loading server; and c) erasing the backed up data. Finally, upon detection by the accelerometer that the hard disk has stopped moving, the erased data is wirelessly recovered from the uploading server.

In yet another embodiment of the invention, a light-triggered safety mechanism is provided along with the above-referenced location-based and movement-based safety measures. In this embodiment, the user is prompted in order to enable a light-intensity feature. The feature causes the hard disk to back up data if and when the photoresistor detects that there is reduced light received by the hard disk. The users answer, besides the location-based and movement based information, also contains information pertaining the change in luminosity sufficient to trigger data backup. One, two, or all three of the safety features are configured in response to the received answers.

Referring still to this embodiment, if the photoresistor detects that the hard disk has received reduced light, then the following steps are taken: a) backing up the data with respect to the orientation movement; b) uploading the backed data wirelessly through the wireless transmitter to the loading server; and c) erasing the backed up data. Then, if it is detected by the photoresistor that the hard disk has received more light, the erased data is wirelessly recovered from the uploading server.

Referring still to this embodiment, if the hard disk is determined to be within a dangerous reception area, and movement is detected consistent with the user-denoted orientation movement, then the following steps are taken: a) backing up the data with respect to the orientation movement; b) uploading the backed data wirelessly through the wireless transmitter to the loading server; and c) erasing the backed up data. Finally, upon leaving the sub-geographic region labeled as the dangerous reception area, determining, with the location-identification device, the current location to be within the safe reception area, and detecting, with the accelerometer, that the hard disk has stopped moving, then the erased data is recovered wirelessly.

In accordance with these and other objects which will become apparent hereinafter, the invention will now be described with particular reference to the drawing.

### BRIEF DESCRIPTION OF THE DRAWINGS

FIG. 1 shows a hard drive equipped with safety features according to embodiments of the invention.

### DETAILED DESCRIPTION

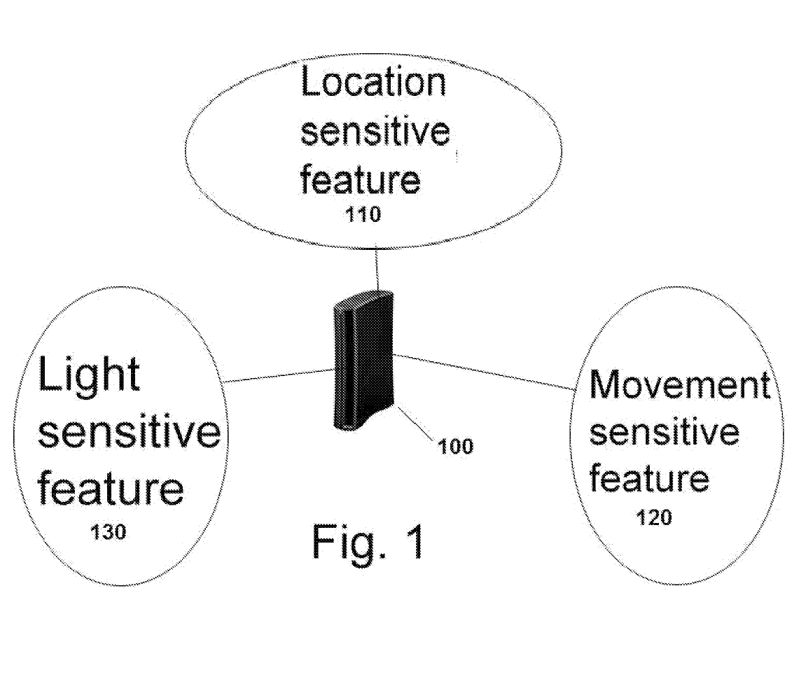

Referring now to the FIGURE, a hard drive 100 is provided for allowing provisioning of safety features is provided. The hard drive 100 is equipped with several safety features in order to ensure that no important data is lost or destroyed due to external forces acting upon it. In FIG. 1, a hard drive 100 is shown comprising three such features.

The location-sensitive feature 110 uses a location-identifying device and an uploading server associated with a phone carrier. This feature employs user-provided information to take preconfigured safety measures based upon the location of the hard disk. For example, if the hard disk is located in a dangerous reception area, the data stored thereon is backed up to a remote server and erased from the hard drive. The location-sensitive feature 110 will be described in greater detail below.

The movement sensitive feature 120 uses an accelerometer to detect movement of the hard drive. If the accelerometers magnitude of movement is beyond a pre-specified threshold, then the data is backed up to a remote server and erased from the hard drive. The movement sensitive feature 120 will be described in greater detail below.

The light sensitive feature 130 uses a light detecting photoresistor to detect changes in light around the hard disk. Changes in light frequency around the disk may suggest that intrusive objects or beings may be approaching the hard disk. Thus, in response to such changes, the data is backed up to a remote server and erased from the hard drive. The light sensitive feature 130 will be described in greater detail below.

Data is valuable to personal market as well as to the commercial market. Such a device enables hard drive manufacturers to better cater to their customers needs by providing a more secure form of data storage.

The hard disk 100 generally comprises the following components: a location identifying device, an accelerator, a photo resistor, a wireless transmitter, an uploading server associated with a phone carrier, a processor, and a memory storage device. These components are employed to provide the safety features 110, 120 and 130.

The memory stores instructions to be executed by the processor, and are as follows. Initially, an instruction is wirelessly received from a user in order to enable a safety feature with respect to the hard disk 100. The user is an end user of a mobile phone, whose network coverage from the phone carrier includes a geographic area. The geographic area may be, but is not limited to, the boundaries of a State or Country. Next, the user is prompted for information needed in order to enable a safety feature. The information asked of the user may include information regarding: the sub-geographic region that is a smaller region within the geographic area, wherein the sub-geographic region is labeled as a dangerous reception area; a sub-sub-geographic region that is a smaller region within the sub-geographic area, wherein the sub-sub-geographic region is labeled as a safe reception area; a building that is within the geographic area, wherein the building is labeled as a very dangerous reception area; a floor of the building, wherein the floor is labeled as a safe reception area; an embassy building that is within the geographic area, wherein the embassy building is labeled as an extremely dangerous reception area; and an open area within the embassy, wherein the open area is labeled as a safe reception.

An answer is then received. The answer includes information regarding sub-geographic region, the sub-sub-geographic region, the building, the floor of the building, the embassy, and the open area.

Next, the safety feature is enabled in view of the received answer to complete configuration thereof. Then, upon receiving information regarding the sub-geographic region labeled as the dangerous reception area by a third party unknown to the user, and determining, with the location-identification device, the current location to be within the dangerous reception area, the following steps are taken: a) backing up data located in certain predefined sectors of the hard disk 100, wherein the sectors are regarded as sensitive areas; b) uploading the backed data wirelessly through the wireless transmitter to the loading server; and c) erasing the backed up data

Finally, upon leaving the sub-geographic region labeled as the dangerous reception area, and determining, with the location-identification device, the current location to be within the safe reception area, the erased data is recovered wirelessly.

In another embodiment of the invention, the user is further prompted for additional information regarding movement of the hard disk 100. The user is asked to denote an orientation change, which, when triggered, would cause the hard disk 100 to back up data. The user's answer, along with the location-based data referred to above, would contain information regarding the magnitude and direction of an orientation change sufficient to trigger data backup. The safety features are then configured in response to the user's answers.

In this embodiment, upon detection, by the accelerometer, that the hard disk is being moved in a way consistent with the denoted orientation movement, the following steps are taken: a) backing up the data with respect to the orientation movement; b) uploading the backed data wirelessly through the wireless transmitter to the loading server; and c) erasing the backed up data. Finally, upon detection by the accelerometer that the hard disk 100 has stopped moving, the erased data is wirelessly recovered from the uploading server.

In yet another embodiment of the invention, a light-triggered safety mechanism is provided along with the above-referenced location-based and movement-based safety measures. In this embodiment, the user is prompted in order to enable a light-intensity feature. The feature causes the hard disk 100 to back up data if and when the photoresistor detects that there is reduced light received by the hard disk 100. The users answer, besides the location-based and movement based information, also contains information pertaining the change in luminosity sufficient to trigger data backup. Then one, two, or all three of the safety features are configured in response to the received answers.

Referring still to this embodiment, if the photoresistor detects that the hard disk 100 has received reduced light, then the following steps are taken: a) backing up the data with respect to the orientation movement; b) uploading the backed data wirelessly through the wireless transmitter to the loading server; and c) erasing the backed up data. Then, if it is detected by the photoresistor that the hard disk 100 has received more light, the erased data is wirelessly recovered from the uploading server.

Referring still to this embodiment, if the hard disk 100 is determined to be within a dangerous reception area, and movement is detected consistent with the user-denoted orientation movement, then the following steps are taken: a) backing up the data with respect to the orientation movement; b) uploading the backed data wirelessly through the wireless transmitter to the loading server; and c) erasing the backed up data. Finally, upon leaving the sub-geographic region labeled as the dangerous reception area, determining, with the location-identification device, the current location to be within the safe reception area, and detecting, with the accelerometer, that the hard disk 100 has stopped moving, then the erased data is recovered wirelessly.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A hard disk for allowing provisioning of safety features, comprising:
a location identifying device;
an accelerator;
a photoresistor;
a wireless transmitter;
an uploading server associated with a phone carrier;
a processor; and
a memory storage device, said memory storing instructions to be executed by the processor.

2. The hard disk of claim 1, wherein the instructions comprise:
wirelessly receiving an instruction from a user to enable a safety feature with respect to the hard disk, wherein the user is an end user of a mobile phone whose network coverage from the phone carrier includes a geographic area;
prompting the user for information in order to enable a safety feature that allows the user to denote:
i. a sub-geographic region that is a smaller region within the geographic area, wherein the sub-geographic region is labeled as a dangerous reception area;
ii. a sub-sub-geographic region that is a smaller region within the sub-geographic area, wherein the sub-sub-geographic region is labeled as a safe reception area;
iii. a building that is within the geographic area, wherein the building is labeled as a very dangerous reception area;
iv. a floor of the building, wherein the floor is labeled as a safe reception area;
v. an embassy building that is within the geographic area, wherein the embassy building is labeled as an extremely dangerous reception area; and
vi. an open area within the embassy, wherein the open area is labeled as a safe reception area;
receiving an answer from the user, wherein the answer includes information regarding:
i. the sub-geographic region;
ii. the sub-sub-geographic region;
iii. the building;
iv. the floor of the building;
v. the embassy; and
vi. the open area;
enabling the safety feature in view of the received answer to complete configuration thereof;
upon receiving information regarding the sub-geographic region labeled as the dangerous reception area by a third party unknown to the user, and determining, with the location-identification device, the current location to be within the dangerous reception area:
a. backing up data located in certain predefined sectors of the hard disk, wherein the sectors are regarded as sensitive areas;
b. uploading the backed data wirelessly through the wireless transmitter to the loading server; and
c. erasing the backed up data; and
Upon leaving the sub-geographic region labeled as the dangerous reception area, and determining, with the location-identification device, the current location to be within the safe reception area; recovering the erased data wirelessly.

3. The hard disk of claim 1, wherein the instructions comprise:
wirelessly receiving an instruction from a user to enable a safety feature with respect to the hard disk, wherein the user is an end user of a mobile phone whose network coverage from the phone carrier includes a geographic area;
prompting the user for information in order to enable a safety feature that allows the user to denote:
i. a sub-geographic region that is a smaller region within the geographic area, wherein the sub-geographic region is labeled as a dangerous reception area;
ii. a sub-sub-geographic region that is a smaller region within the sub-geographic area, wherein the sub-sub-geographic region is labeled as a safe reception area;
iii. a building that is within the geographic area, wherein the building is labeled as a very dangerous reception area;
iv. a floor of the building, wherein the floor is labeled as a safe reception area;
v. an embassy building that is within the geographic area, wherein the embassy building is labeled as an extremely dangerous reception area; and
vi. an open area within the embassy, wherein the open area is labeled as a safe reception area;
further prompting the user for information in order to enable another safety feature that allows the user to denote an orientation change, which, when detected, causes the hard disk to perform a function;
receiving an answer from the user, wherein the answer includes information regarding:
i. the magnitude and direction of an orientation movement sufficient to trigger data backup;
ii. the sub-geographic region;
iii. the sub-sub-geographic region;
iv. the building;
v. the floor of the building;
vi. the embassy; and
vii. the open area;
configuring one or more safety features in response to the answer;
upon detection, by the accelerometer, that the hard disk is being moved in a way consistent with the denoted orientation movement:
a. backing up the data with respect to the orientation movement;
b. uploading the backed data wirelessly through the wireless transmitter to the loading server; and
c. erasing the backed up data; and
upon detection, by the accelerometer, that the hard disk stops moving; recovering the erased data wirelessly from the uploading server.

4. The hard disk of claim 1, wherein the instructions comprise:
wirelessly receiving an instruction from a user to enable a safety feature with respect to the hard disk, wherein the user is an end user of a mobile phone whose network coverage from the phone carrier includes a geographic area;
prompting the user for information in order to enable a safety feature that allows the user to denote:
i. a sub-geographic region that is a smaller region within the geographic area, wherein the sub-geographic region is labeled as a dangerous reception area;
ii. a sub-sub-geographic region that is a smaller region within the sub-geographic area, wherein the sub-sub-geographic region is labeled as a safe reception area;
iii. a building that is within the geographic area, wherein the building is labeled as a very dangerous reception area;
iv. a floor of the building, wherein the floor is labeled as a safe reception area;
v. an embassy building that is within the geographic area, wherein the embassy building is labeled as an extremely dangerous reception area; and
vi. an open area within the embassy, wherein the open area is labeled as a safe reception area;
prompting the user for information in order to enable another safety feature that allows the user to denote an orientation change, which, when triggered, would cause the hard disk to perform a function;
prompting the user for information in order to enable a light-intensity feature, the feature causing the hard disk to perform a function if and when the photoresistor detects that there is reduced light received by the hard disk;
receiving an answer from the user, wherein the answer includes information regarding:
i. a change in light-intensity sufficient to trigger data backup;
ii. the magnitude and direction of an orientation movement sufficient to trigger data backup;
iii. the sub-geographic region;
iv. the sub-sub-geographic region;
v. the building;
vi. the floor of the building;
vii. the embassy; and
viii. the open area;
configuring one or more safety features in response to the received answer;
upon detection, by the photoresistor, that the hard disk has received reduced light:
a. backing up the data;
b. uploading the backed data wirelessly through the wireless transmitter to the loading server;
c. erasing the backed up data;
upon detection, by the photoresistor, that the hard disk has received more light; recovering the erased data wirelessly from the uploading server.
upon receiving information regarding the sub-geographic region labeled as the dangerous reception area by a third party unknown to the user, and determining, with the location-identification device, the current location to be within the dangerous reception area, and upon detection, by the accelerometer, that the hard disk is being moved in a way consistent with the denoted orientation movement:
a. backing up the data;
b. uploading the backed data wirelessly through the wireless transmitter to the loading server; and
c. erasing the backed up data; and
upon receiving information regarding the sub-geographic region labeled as the dangerous reception area by a third party unknown to the user, determining, with the location-identification device, the current location to be within the dangerous reception area, and detection by the accelerometer, that the hard disk stops moving; recovering the erased data wirelessly from the uploading server.
